(19) United States
(12) Patent Application Publication
(10) Pub. No.: US 2019/0114941 A1
(43) Pub. Date: Apr. 18, 2019

(54) WORK ASSISTANCE SYSTEM, KITCHEN ASSISTANCE SYSTEM, WORK ASSISTING METHOD, AND NON-TRANSITIVE COMPUTER-READABLE MEDIUM RECORDING PROGRAM

(71) Applicant: PANASONIC INTELLECTUAL PROPERTY MANAGEMENT CO., LTD., Osaka (JP)

(72) Inventors: Yuusaku SHIMAOKA, Osaka (JP); Takayuki MOHRI, Tokyo (JP)

(21) Appl. No.: 16/164,369

(22) Filed: Oct. 18, 2018

(30) Foreign Application Priority Data
Oct. 18, 2017 (JP) 2017-202076

(51) Int. Cl. G09B 19/00; G06K 9/00

(52) U.S. Cl. CPC G09B 19/003; G10L 13/043; G06K 9/00624

(57) ABSTRACT

The work assistance system assists work including a plurality of steps. The work assistance system includes a determination unit and an announcement control unit. The determination unit determines, based on an image of a working area, whether a working result of a determination target step of the plurality of steps is acceptable or unacceptable. The announcement control unit orders an announcement unit to perform announcement operation when the working result of the determination target step has been determined to be unacceptable by the determination unit.

### CROSS-REFERENCE TO RELATED APPLICATION

The present application is based upon and claims the benefit of priority of Japanese Patent Application No. 2017-202076, filed on Oct. 18, 2017, the entire contents of which are incorporated herein by reference.

### TECHNICAL FIELD

The present disclosure relates to work assistance systems, kitchen assistance systems, work assisting methods, and non-transitive computer-readable media, and in particular to a work assistance system, a kitchen assistance system, a work assistance method, and a non-transitive computer-readable medium which are suitable for work including a plurality of steps.

### BACKGROUND ART

JP 2002-342440 A (hereinafter, referred to as “document 1”) discloses a kitchen video system used in restaurants and the like. The kitchen video system of document 1 includes an electronic cash register and a display controller. The electronic cash register has a function of sending information of a customer's ordered item to the display controller. The display controller has a function of displaying information of the ordered item sent from the electronic cash register, on monitors. The monitors are installed in a cooking place where foods are prepared, an assembly place where prepared foods and the like are assembled, and the like.

The video kitchen system of document 1 enables a cooking staff (worker) to confirm the ordered item displayed on a monitor installed in the cooking place and then cook. However, the cooking staff may make mistakes in cooking procedure (work procedure).

### SUMMARY

An object of the present disclosure would be to propose a work assistance system, a kitchen assistance system, a work assistance method, and a non-transitive computer-readable medium which are capable of reducing failure in work.

A work assistance system of one aspect according to the present disclosure is for assisting work including a plurality of steps. The work assistance system of this aspect includes a determination unit and an announcement control unit. The determination unit is configured to determine whether a work result of a determination target step of the plurality of steps is acceptable or unacceptable, based on an image of a work area. The announcement control unit is configured to order an announcement unit to perform announcement operation, when the work result of the determination target step has been determined to be unacceptable by the determination unit.

A kitchen assistance system of one aspect according to the present disclosure includes the work assistance system, the work including the plurality of steps is cooking work in a kitchen.

A work assisting method of one aspect according to the present disclosure includes a determination process and an announcement control process. The determination process is a process of determining whether a work result of a determination target step of a plurality of steps is acceptable or unacceptable, based on an image of a work area. The announcement control process is a process of ordering an announcement unit to perform announcement operation, when the work result of the determination target step has been determined to be unacceptable by the determination process.

A non-transitive computer-readable medium of one aspect according to the present disclosure records a program. The program is for instructing a computer system to execute: a determination process of determining whether a work result of a determination target step of a plurality of steps is acceptable or unacceptable, based on an image of a work area; and an announcement control process of ordering an announcement unit to perform announcement operation, when the work result of the determination target step has been determined to be unacceptable by the determination process.

### BRIEF DESCRIPTION OF THE DRAWINGS

FIG. 1 is a block diagram of a work assistance system according to one embodiment of the present disclosure.

FIG. 2 is a perspective view of a cooking counter provided with the above work assistance system.

FIG. 3 is a side view of a cooking counter provided with the above work assistance system.

FIG. 4A to FIG. 4D are explanatory diagrams of images of foods stored in a storage device of the above work assistance system.

FIG. 5A to FIG. 5E are explanatory diagrams of images of foodstuffs stored in the storage device of the above work assistance system.

FIG. 6 is a flow chart for illustration of operation of the above work assistance system.

FIG. 7 is an explanatory diagram of a cooking instruction screen projected by the above work assistance system.

FIG. 8 is an explanatory diagram of another cooking instruction screen projected by the above work assistance system.

FIG. 9 is an explanatory diagram of an announcement screen projected by the above work assistance system.

FIG. 10 is an explanatory diagram of a work recording screen projected by the above work assistance system.

### DETAILED DESCRIPTION

### Embodiments

### (1) Overview

A work assistance system of present embodiment is a system for assisting work including a plurality of steps.

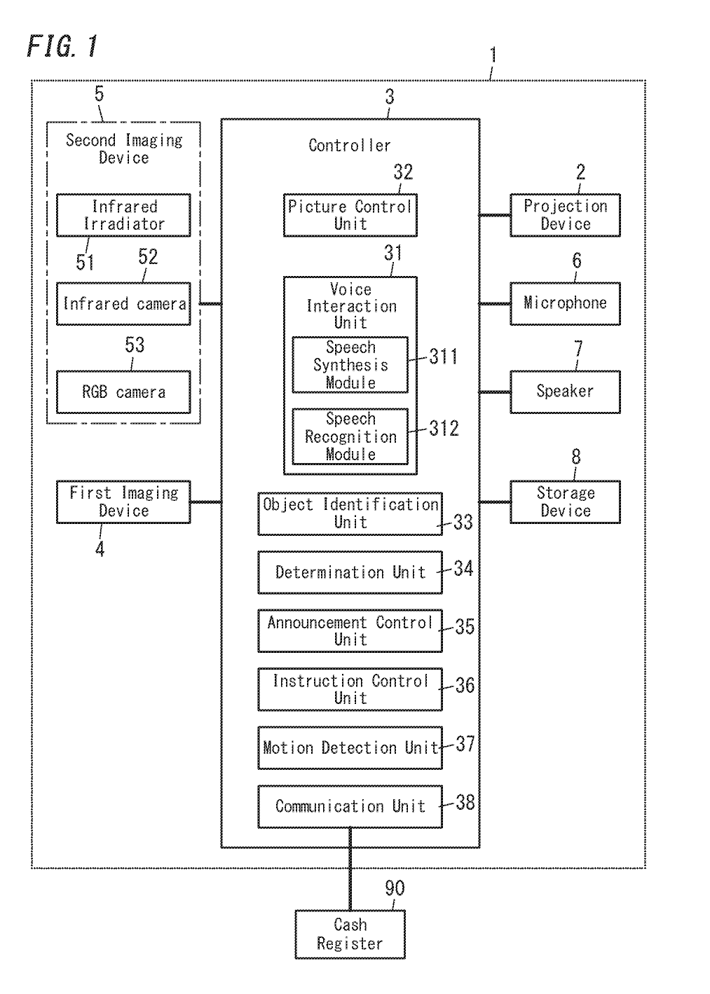

FIG. 1 shows a work assistance system 1 including a determination unit 34 and an announcement control unit 35.

The determination unit 34 is configured to determine whether a work result of a determination target step of the plurality of steps is acceptable or unacceptable, based on an image (digital image) of a work area. In the present embodiment, the “image” of the work area is a static image (digital image) but may be a dynamic image (digital image).

The announcement control unit 35 is configured to order an announcement unit (e.g., a projection device 2, a speaker 7, or the like) to perform announcement operation, when the work result of the determination target step has been determined to be unacceptable by the determination unit 34.

As described above, when the determination unit 34 has determined that the work result of the determination target step is unacceptable, the announcement control unit 35 makes the announcement unit (the projection device 2 or the speaker 7) perform the announcement operation. Therefore, a worker can easily find the work result is unacceptable. Accordingly, it is possible to reduce failure in work.

### (2) Details

Hereinafter, the work assistance system 1 of the present embodiment is described with reference to the drawings. The work assistance system 1 described below is used for assisting cooking work by a worker (cooking staff) in a cooking place such as a kitchen of a fast-food restaurant, for example. In other words, the work assistance system 1 of the present embodiment may be used as a kitchen assistance system.

### (2.1) Configurations

As shown in FIG. 1, the work assistance system 1 of the present embodiment includes a projection device 2, a controller 3, a first imaging device 4, a second imaging device 5, a microphone 6, a speaker 7, and a storage device 8. Note that, the work assistance system 1 of the present embodiment includes a voice interaction function implemented by a set of the microphone 6 and the speaker 7, and a voice interaction unit 31. However, the voice interaction function is optional, and the voice interaction unit 31 and the microphone 6 may be omitted.

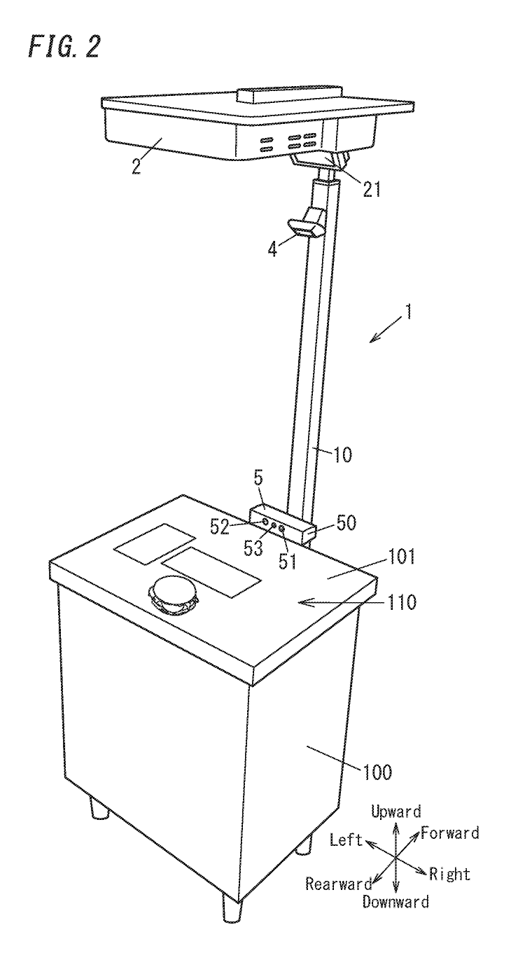

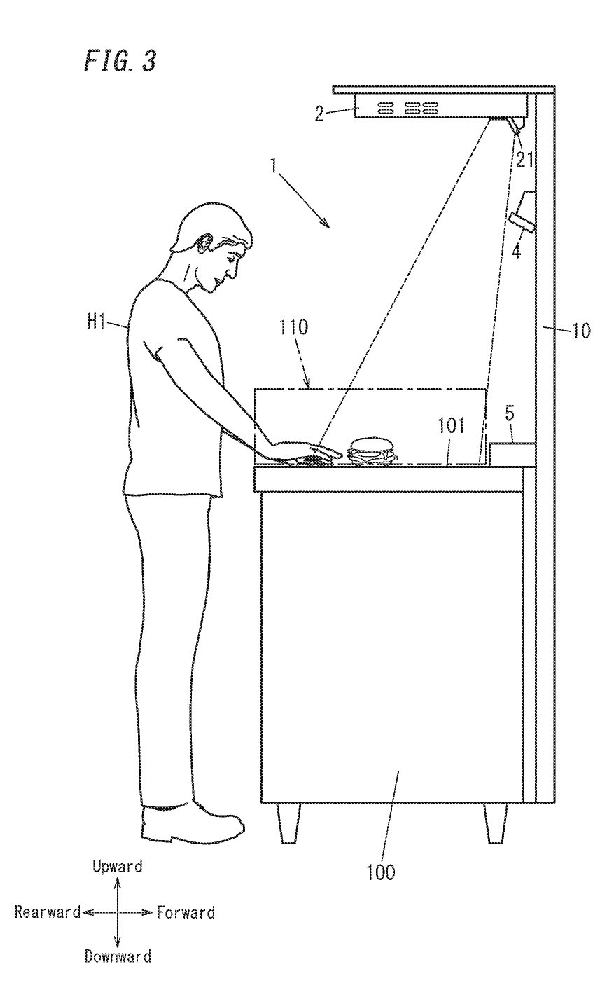

As shown in FIG. 2 and FIG. 3, the work assistance system 1 is provided to a cooking counter 100 where a worker H1 prepares a food ordered by a customer. In the following, directions in FIG. 2 and the like are defined by “upward”, “downward”, “left”, “right”, “forward”, and “rearward” arrows. In other words, upward, downward, left, right, forward, and rearward directions are defined based on directions when the worker H1 performing cooking looks at the work area 110 (a work surface 101 which is an upper surface of the cooking counter 100, and a space above it). However, these defined directions do not give any limitation on directions of the work assistance system 1 in use.

The projection device 2 is supported on a pillar 10 placed in front of the cooking counter 100 to be positioned above the cooking counter 100, for example. The projection device 2 of the present embodiment includes a display such as a projector, and a mirror 21 reflecting a picture output from the display and projecting it, for example. The projection device 2 projects a picture toward the work area 110, that is, onto the work surface 101 of the cooking counter 100. Note that, the projection device 2 makes the mirror 21 reflect a picture output, thereby projecting the picture onto the upper surface (the work surface 101) of the cooking counter 100. However, the projection device 2 may project a picture onto the work surface 101 of the cooking counter 100 directly. Alternatively, the projection device 2 may be provided integrally to the cooking counter 100.

The first imaging device 4 is attached to an upper side of the pillar 10 to shoot (take an image of) the work surface 101 (the work area 110) of the cooking counter 100 from the above. The first imaging device 4 includes an image sensor such as a CMOS (Complementary Metal Oxide Semiconductor) image sensor and a CCD (Charge Coupled Device) image sensor. The first imaging device 4 shoots (takes an image of) the work area 110 including the work surface 101 of the cooking counter 100 and the space above it, in a direction almost perpendicular to the work surface 101. Note that, the first imaging device 4 takes a color image, but may take a monochrome image.

The second imaging device 5 is placed near a front end of the work surface 101 of the cooking counter 100 to shoot (take an image of) the work surface 101 of the cooking counter 100. The second imaging device 5 shoots (takes an image of) the work area 110 including the work surface 101 of the cooking counter 100 and the space above it, in a direction across the upward and downward directions (in the present embodiment, the forward and rearward directions perpendicular to the upward and downward directions). The second imaging device 5 includes an infrared irradiator 51, an infrared camera 52, an RGB camera 53, and a case 50. The infrared irradiator 51, the infrared camera 52, and the RGB camera 53 are arranged in a front surface (a surface close to the work area 110) of the case 50 (see FIG. 2).

The RGB camera 53 includes an imaging element such as a CCD image sensor and a CMOS image sensor. The RGB camera 53 takes a two-dimensional color image of the work area 110 at a predetermined frame rate (e.g., 10 to 80 frames per sec).

The infrared irradiator 51 and the infrared camera 52 form a distance image sensor measuring a distance by a TOF (Time of Flight) method, for example. The infrared irradiator 51 emits infrared light toward the work area 110. The infrared camera 52 includes a light receiving element with sensitivity for infrared light such as a CCD image sensor and a CMOS image sensor, and thereby receives infrared light. The infrared camera 52 and the RGB camera 53 are arranged in the case 50 to face in the same direction. The infrared camera 52 receives light which is emitted from the infrared irradiator 51 and then reflected from an object (e.g., foodstuffs, cooking instruments, hands of the worker H1, or the like) present in the work area 110. The distance image sensor can measure a distance to an object based on time from emission of infrared light from the infrared irradiator 51 to reception of the infrared light by the infrared camera 52.

Thus, the second imaging device 5 outputs the two-dimensional color image taken by the RGB camera 53 and a distance image taken by the infrared camera 52 to the controller 3. In this regard, the distance image is defined as a grayscale image representing distances to objects by gray shades. Alternatively, the second imaging device 5 may output a monochrome image and a distance image. Further, the infrared irradiator 51, the infrared camera 52, and the RGB camera 53, of the second imaging device 5 are housed in the single case 50. Alternatively, the infrared irradiator 51, the infrared camera 52, and the RGB camera 53 may be distributedly arranged in two or more cases.

The microphone 6 converts a sound such as a voice produced by the worker H1 into an electric signal, and outputs it to the controller 3.

The speaker 7 converts an electric signal input from the controller 3 into a sound, and outputs it.

The microphone 6 and the speaker 7 may be attached to a body of the projection device 2, the pillar 10, the case 50 of the second imaging device 5, the cooking counter 100, or the like. Or, the worker H1 may wear a headset including at least one of the microphone 6 and the speaker 7. In this case, at least one of the microphone 6 and the speaker 7, and the controller 3 may establish wireless communication with each other by a wireless scheme such as Bluetooth (registered trademark).

The storage device 8 includes a storage device such as a hard disc drive, a memory card, and the like. The storage device 8 may store information of materials (e.g., foodstuffs and seasoning) used in each food, information indicating cooking procedure, image data of cooking instruction screens for indicating cooking procedure to be projected by the projection device 2, and the like. Further, the storage device 8 may store one or more programs to be executed by a computer system of the controller 3 described below, or the like. To change a recipe of a food or add a new food is required, it is sufficient to update information of a food, program(s) executed by computer system(s) of the controller 3, and the like stored in the storage device 8. Accordingly, change of a recipe and addition of a food can be done easily.

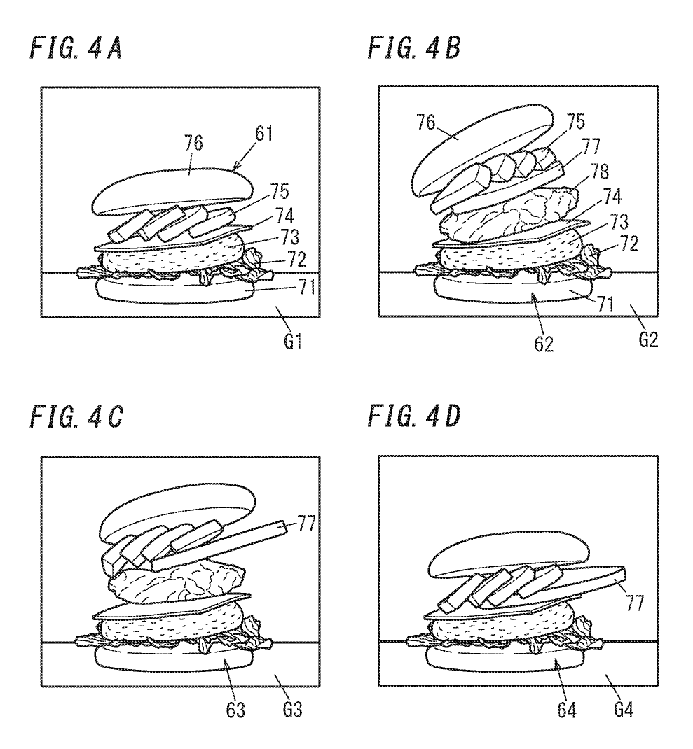

Additionally, the storage device 8 stores, for each food, image data including a set of images representing non-defective products for determining that cooking work has succeeded, a set of images representing defective products for determining that cooking work has failed, and the like, which are taken by the first imaging device 4, the second imaging device 5, and the like. In this regard, each of the set of images representing non-defective products and the set of images representing defective products includes images corresponding to individual steps, and images taken in work, images taken after completion of work. The storage device 8 stores at least one of defective information indicative of defect(s) in cooking work and correction information indicative correction item(s) for correcting defect(s), in association with image date of the set of images representing defective products. FIG. 4A to FIG. 4D are images G1 to G4 representing side views of finished hamburgers 61 to 64, respectively. The storage device 8 stores image data of the images G1 to G4. The image G1 is an image of the hamburger 61 determined to be a non-defective product. For example, the hamburger 61 in the images G1 is made by stacking a sliced bun 71, leaves of lettuce 72, a beef patty 73, a slice of cheese 74, slices of avocado 75, and a sliced bun 76 in this order from the bottom. In contrast, the images G2, G3, and G4 are images of the hamburgers 62, 63, and 64 determined to be defective products. As to the hamburger 62 in the image G2, a fried cutlet 78 and a slice of tomato 77 are added between a slice of cheese 74 and slices of avocado 75 in contrast to the hamburger 61, and the hamburger 62 leans due to an untidy pile of foodstuffs. As to the hamburgers 63 and 64 in the images G3 and G4, a slice of tomato 77 is placed to protrude outwardly. Therefore, the hamburgers 63 and 64 have poor appearance, and uniform taste is not expected when eating. The storage device 8 stores image data of images of non-defective products and defective products other than the images G1 to G4. The storage device 8 stores images of defective products which include images corresponding to various reasons why products are determined to be defective.

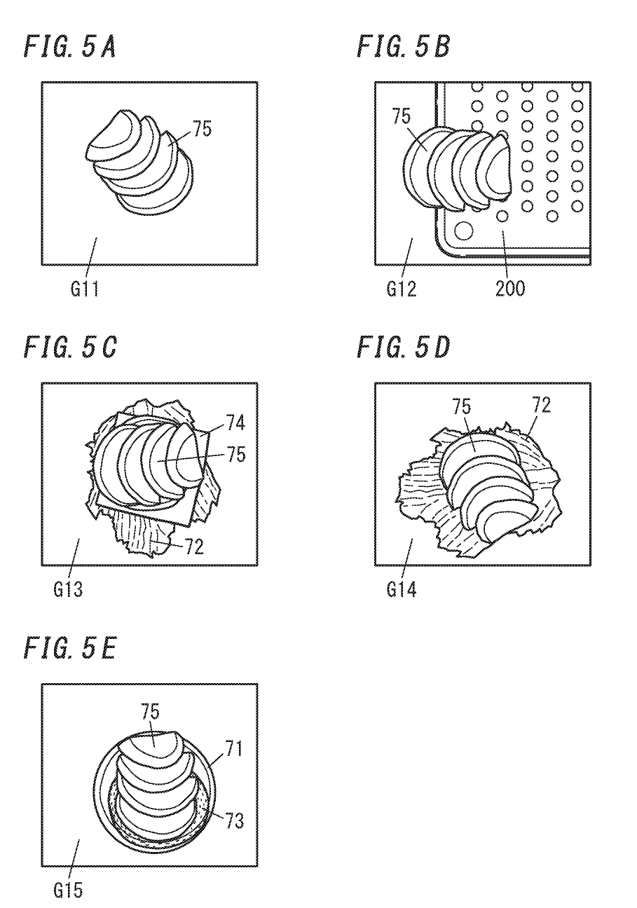

Further, the storage device 8 stores image data of images representing foodstuffs. FIG. 5A to FIG. 5E are some of images of foodstuffs stored in the storage device 8, and the images G11 to G15 shown in FIG. 5A to FIG. 5E are images representing avocado 75 which is one of the foodstuffs. The image G11 of FIG. 5A shows avocado 75 only, and is an image of a scene where slices (e.g., four slices) of avocado 75 are piled on the cooking counter 100. The image G12 of FIG. 5B is an image of a scene where slices of avocado 75 are put on a metal cooking tray 200. The image G13 of FIG. 5C is an image of a scene where slices of avocado 75 are arranged in accordance with predetermined correct cooking procedure, and the slices of avocado 75 are put on a slice of cheese 74. The images G14 and G15 of FIG. 5D and FIG. 5E are images corresponding to wrong cooking procedure. In the image G14 of FIG. 5D, slices of avocado 75 are put on leaves of lettuce 72. In the image G15 of FIG. 5E, slices of avocado 75 are put on a beef patty 73. As described above, the storage device 8 stores, as image data of foodstuffs, image data of images which are different in at least one of conditions which are a shooting direction, a lighting environment, a combination of foodstuffs, and the like.

Furthermore, the storage device 8 stores image data of images representing the work area 110 in each step for each food. Particularly, the images representing the work area 110 in each step stored in the storage device 8 include images different in at least one of conditions including a shooting direction, a lighting environment, and the like. Further, the images representing the work area 110 in each step stored in the storage device 8 include one or more images corresponding to acceptable work results, and one or more images corresponding to unacceptable work results. In this regard, at least one of defective information indicative of defect(s) in cooking work and correction information indicative correction item(s) for correcting defect(s) is stored in the storage device 8 in association with an image of a scene where a work result is unacceptable.

Moreover, the storage device 8 stores image data of images (recorded image) obtained by shooting the work area 110 at each step of cooking work performed by the worker H1. In the present embodiment, the storage device 8 does not store only an image corresponding to a step a work result of which is determined to be unacceptable, but stores images corresponding to all the steps.

The controller 3 includes the voice interaction unit 31, a picture control unit 32, an object identification unit 33, the determination unit 34, the announcement control unit 35, an instruction control unit 36, a motion detection unit 37, and a communication unit 38.

The controller 3 includes a computer system including one or more processors and one or more memories. The one or more processors of the computer system execute one or more programs stored in the one or more memories of the computer system or the storage device 8, thereby realizing functions of the controller 3. The one or more programs executed by the one or more processors of the computer system may be stored in the one or more memories or the storage device 8 in advance, or may be supplied through telecommunications circuits such as the Internet, or may be provided with they being recorded in a non-transitive recording medium such as memory cards.

The voice interaction unit 31 includes a speech synthesis module 311 and a speech recognition module 312. The speech synthesis module 311 synthesizes speech by synthesis such as concatenative synthesis and formant synthesis, and outputs it from the speaker 7. The speech recognition module 312 recognizes a voice inputted into the microphone 6 by use of hidden Markov model, for example. The voice interaction unit 31 enables voice interaction by use of a set of the speech synthesis module 311 and the speech recognition module 312, the microphone 6, and the speaker 7.

The picture control unit 32 controls operation in which the projection device 2 projects a picture toward the work area 110. The picture control unit 32 orders the projection device 2 to project a picture such as a cooking related picture indicating cooking procedure, a picture for announcing work defects, and a picture based on a recorded image. The cooking related picture includes a cooking instruction screen indicating, regarding cooking work including a plurality of steps, work procedure for each step. The picture control unit 32 controls the projection device 2 to project a picture such as the cooking instruction screen, toward the work area 110.

The object identification unit 33 generates in advance a learned model for identifying foodstuffs from images of the work area 110 by machine learning or deep learning using images of foodstuffs stored in the storage device 8. The object identification unit 33 identifies an object (foodstuffs, cooking instruments, hands of the worker H1, or the like) present in the work area 110 by use of the learned model based on any of an image taken by the RGB camera 53 and an image taken by the first imaging device 4. Note that, the storage device 8 stores images of scenes where a plurality of objects combined, and the object identification unit 33 identifies objects by use of a learned model produced by machine learning or deep learning using these images. Thus, the object identification unit 33 can identify individual objects more accurately even when the objects are combined.

Note that, the object identification unit 33 of the present embodiment detects an object (foodstuffs, cooking instruments, hands of the worker H1, or the like) in the work area 110 based on an image take by the RGB camera 53 and an image taken by the first imaging device 4. For example, the object identification unit 33 conducts background subtraction to subtract background images from images taken by the RGB camera 53 and the first imaging device 4, respectively, thereby detecting objects which are not present in the background images. Then, the object identification unit 33 inputs the individual objects detected from the images taken by the RGB camera 53 and the first imaging device 4 into the learned model, to identify an object present in the work area 110. Note that, the object identification unit 33 may perform relearning of the learned model by use of images obtained by shooting the work area 110 in work. Thus, determination accuracy can be improved.

The determination unit 34 generates in advance a learned model for determining whether a work result is acceptable or unacceptable, by machine learning or deep learning using images of the work area 110 (including an image corresponding to an acceptable work result and an image corresponding to an unacceptable work result) in each step stored in the storage device 8. Additionally, the determination unit 34 generates in advance a learned model for determining a correction item for correcting a work result determined to be unacceptable, by machine learning or deep learning using images of defective products stored in the storage device 8. Note that, the determination unit 34 may perform relearning of the learned model by use of images obtained by shooting the work area 110 in work. Thus, determination accuracy can be improved.

The determination unit 34 inputs individual images of the work area 110 taken by the first imaging device 4 and the second imaging device 5 into the learned model, thereby determining that an object present in the work area 110 is which foodstuff. Further, the determination unit 34 inputs individual images of the work area 110 taken by the first imaging device 4 and the second imaging device 5 into the learned model, thereby determining that a current step corresponds to which step and determining whether a work result of the current step is acceptable or unacceptable. Additionally, when determining the work result of the determination target step is unacceptable, the determination unit 34 inputs the work result determined to be unacceptable into the learned model, thereby determining the correction item for correcting the work result determined to be unacceptable.

The announcement control unit 35 is configured to, when the work result of the determination target step has been determined to be unacceptable by the determination unit 34, order the announcement unit (e.g., the projection device 2, the speaker 7, and the like) to perform predetermined announcement operation. In this regard, the predetermined announcement operation may include operation of announcing that the work result of the determination target step is unacceptable. For example, the announcement control unit 35 generates an image including information for announcing that the work result of the determination target step is unacceptable. And the announcement control unit 35 orders the projection device 2 to project the image generated, onto the work surface 101 of the cooking counter 100. Additionally, for example, the announcement control unit 35 generates a speech message or an announcement sound including information for announcing that the work result of the determination target step is unacceptable, and outputs the generated speech message or announcement sound from the speaker 7. Consequently, the worker H1 performing cooking work at the cooking counter 100 can notice that the work result is unacceptable, based on a picture projected by the projection device 2, or the speech message or the announcement sound output from the speaker 7.

The instruction control unit 36 is configured to order an instruction unit (e.g., the projection device 2, the speaker 7, and the like) to give work instructions of a next step of the plurality of steps included in cooking work of a food in preparation. For example, the instruction control unit 36 generates an image including work procedure explaining an action in the next step, and orders the projection device 2 to project the generated image onto the work surface 101 of the cooking counter 100. Additionally, for example, the instruction control unit 36 generates a speech message or an announcement sound explaining the action in the next step and outputs the generated speech message or announcement sound from the speaker 7. Consequently, the worker H1 performing cooking work at the cooking counter 100 can know the work procedure in the next step, based on a picture projected by the projection device 2, or the speech message or the announcement sound output from the speaker 7.

The motion detection unit 37 is configured to detect a motion of the worker H1. Examples of the motion of the worker H1 may include a motion with hands of the worker H1. When the object identification unit 33 detects hands of the worker H1, the motion detection unit 37 traces movement of hands of the worker H1, thereby detecting motion (gesture) done by the worker H1. Note that, the motion detection unit 37 is optional for the work assistance system 1 and may be omitted appropriately.

The communication unit 38 is configured to communicate with a cash register 90 placed on a counter or the like of a fast-food restaurant, for example. The communication unit 38 includes a communication module compliant with a communication standard of Ethernet (registered trademark), for example. When a staff operating the cash register 90 receives order of a food from a customer and inputs the order of the food into the cash register 90, the cash register 90 calculates a transaction amount of the input food. The cash register 90 sends order information indicative of an ordered food input by the staff, to the work assistance system 1, and this order information is received by the communication unit 38. Note that, the communication unit 38 is optional for the work assistance system 1 and may be omitted appropriately.

### (2.2) Operation

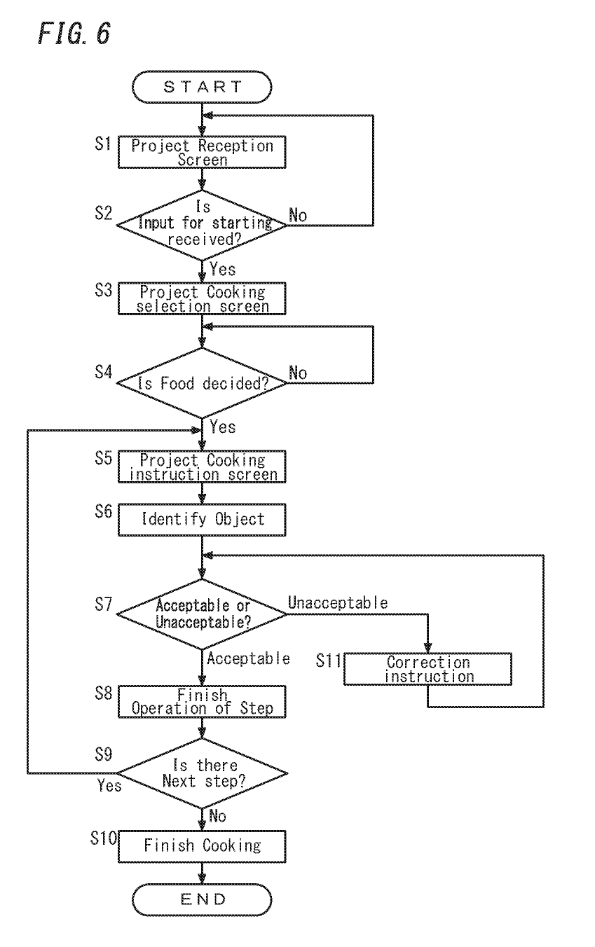

Operation of the work assistance system 1 of the present embodiment assisting the cooking work by the worker H1 is described with reference to a flow chart of FIG. 6 and the like.

Unless the operation for assisting the cooking work is being performed, the picture control unit 32 of the controller 3 projects a reception screen for receiving input for starting the operation, from the projection device 2, onto the work surface 101 of the cooking counter 100 (S1), and waits for the input (S2).

When the worker H1 makes predetermined motion while the reception screen is projected onto the work surface 101 (S2: Yes), the motion detection unit 37 detects the motion of the worker H1. For example, the predetermined motion may be motion made by the worker H1 to input identification information (e.g., an ID (identity) number) of the worker and instructions for starting the operation. The controller 3 starts the operation for assisting the cooking work when the motion detection unit 37 has detected the predetermined motion. Note that, when receiving speech for starting the operation produced by the worker H1 while the reception screen is projected onto the work surface 101, the controller 3 may start the operation for assisting the cooking work.

When starting the operation for assisting the cooking work, the controller 3 projects a cooking selection screen for receiving an action for selecting a desired food from a plurality of foods, from the projection device 2 onto the work surface 101 of the cooking counter 100 (S3).

The cooking selection screen shows a plurality of options individually corresponding to the plurality of foods. When the worker H1 makes motion to select an option corresponding to a desired food, the motion detection unit 37 detects the motion of the worker H1 and the controller 3 determines a food to be prepared (S4: Yes).

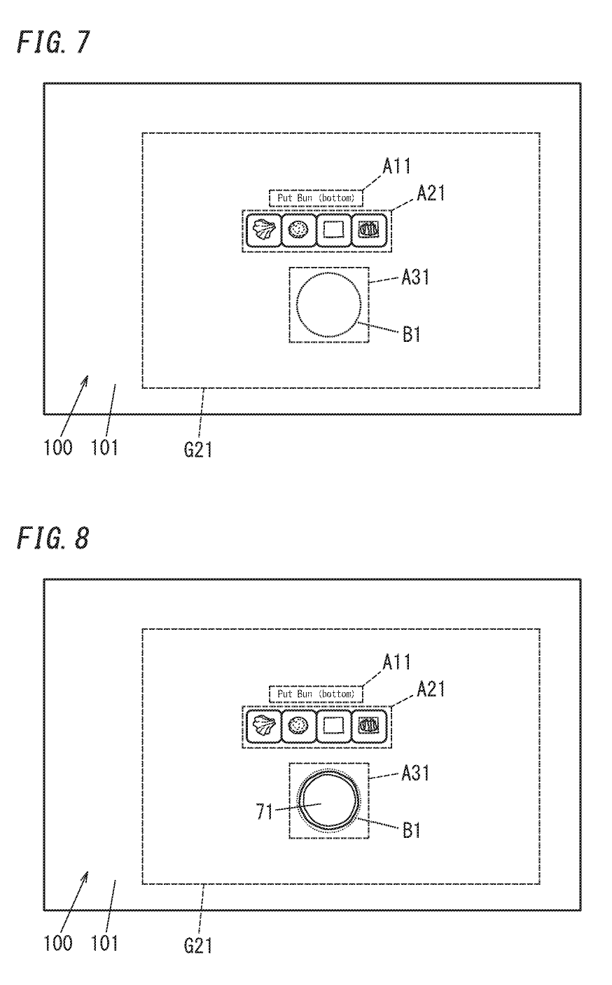

The controller 3 reads out cooking procedure of the food determined in step S4 and the cooking instruction screen from the storage device 8. The instruction control unit 36 generates a cooking instruction screen G21 (see FIG. 7) corresponding to an initial step and projects it from the projection device 2 onto the work surface 101 of the cooking counter 100 (S5). In the example shown in FIG. 7, the cooking instruction screen G21 contains a display area A11 for displaying texts or the like indicating the work procedure, a display area A21 displaying foodstuffs used in preparation by photographs or the like, and a display area A31 displaying the working procedure by illustrative drawings or the like. The display area A11 shows a text “Place sliced bun (bottom)” as the texts indicating the work procedure. The display area A31 shows a pictorial symbol B1 representing the bottom sliced bun. Note that, what is displayed in the display area A31 is not limited to a pictorial symbol, but may be an image such as a photograph of a foodstuff.

When the worker H1 places the bottom sliced bun 71 above the pictorial symbol B1 displayed on the display area A31 of the cooking instruction screen G21 (see FIG. 8), the object identification unit 33 identifies an object placed on the work surface 101 (in this step, the sliced bun 71) and a position of the object (S6). When the object identification unit 33 identifies the object placed on the work surface 101, the determination unit 34 determines whether the work result is acceptable or unacceptable, based on images taken by the first imaging device 4 and the second imaging device 5 (S7).

When determining that the work result is acceptable in step S7, the determination unit 34 determines that operation in the current step is completed (S8). In other words, the determination unit 34 determines that the determination target step has been finished, based on the images taken by the first imaging device 4 and the second imaging device 5. And the determination unit 34 determines a next step (a next determination target step). The controller 3 stores in the storage device 8 image data of an image (a recorded image) of the work area 110 taken by the first imaging device 4 in association with time information indicating elapsed time from start of the operation. Thereafter process of step S9 starts.

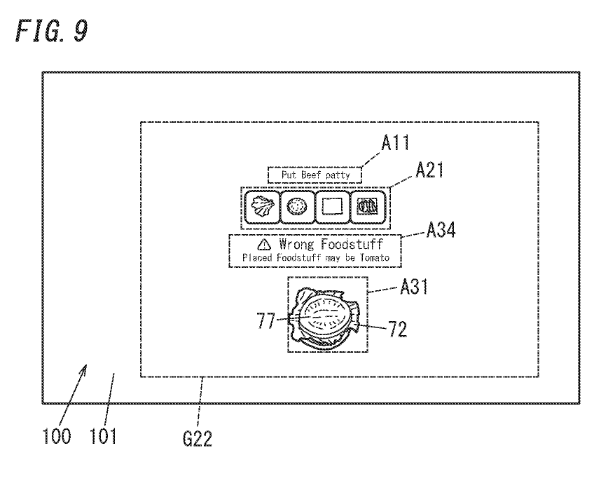

In contrast, when the determination unit 34 has determined that the work result is unacceptable in step S7, the announcement control unit 35 retrieves the correction information corresponding to the defects in the work from the storage device 8, generates a picture including the correction information, and projects it from the projection device 2 onto the work surface 101 of the cooking counter 100 (S11). FIG. 9 shows one example of an announcement screen G22 including correction information. In the example shown in FIG. 9, in a step of placing a beef patty on leaves of the lettuce 72, a slice of tomato 77 is placed instead thereof by mistake. The announcement screen G22 includes the display area A11 for displaying texts or the like indicating the work procedure, the display area A21 displaying foodstuffs used in preparation by photographs or the like, and the display area A34 for displaying correction information. The display area A34 shows, as the correction information, a literal message “wrong foodstuff”, “foodstuff placed thereon may be tomato.”, or the like.

As described above, the announcement control unit 35 announces that the work result is unacceptable. Thus, the worker H1 can easily find that the work result is unacceptable. The worker H1 can be motivated to again perform the step determined to be unacceptable.

When the worker H1 confirms correction instructions projected onto the work surface 101 and then corrects the work result in accordance with the correction instructions, the object identification unit 33 performs process of detecting the object having been corrected and the position thereof. Then, the determination unit 34 determines again whether the work result is acceptable or unacceptable, based on images taken by the first imaging device 4 and the second imaging device 5 after correction (S7).

When the determination unit 34 has determined the work result is acceptable in step S7, the controller 3 determines that the operation in the current step has been finished (S8). The controller 3 stores in the storage device 8 image data of an image (a recorded image) of the work area 110 taken by the first imaging device 4 in association with time information indicating elapsed time from start of the operation. Thereafter process of step S9 starts.

In step S9, the controller 3 it is determined whether or not a next step exists.

When the next step is determined to exist in step S9, the instruction control unit 36 generates a cooking instruction screen corresponding to the next step, and projects it from the projection device 2 onto the work surface 101 of the cooking counter 100 (S5). The controller 3 repeats processes after step S6.

When the next step is determined not to exist in step S9, the controller 3 determines cooking has been finished (S10), and does not start its operation unless start of next cooking.

As described above, in the work assistance system 1 of the present embodiment, the announcement control unit 35 is configured to, when the work result has been determined to be unacceptable by the determination unit 34, order the projection device 2 serving as the announcement unit to perform the announcement operation for announcing a correction item before operation in the next step is started. Accordingly, the worker H1 can easily find that the work result is unacceptable. The worker H1 can also relatively easily correct the work result. Note that, in the present embodiment, the announcement control unit 35 orders the projection device 2 serving as the announcement unit to announce the correction item for correcting the work result having been determined to be unacceptable. Alternatively, the announcement control unit 35 may order the projection device 2 to announce that the work result has been determined to be unacceptable. This configuration may offer advantageous effects that the worker H1 can easily find that the work result is unacceptable.

Note that, in the work assistance system 1 of the present embodiment, the instruction control unit 36 is configured not to give instructions of the next step until the work result is determined to be acceptable by the determination unit 34. Therefore, a food is prevented from being prepared by steps a work result of any of which is unacceptable. Accordingly, the work assistance system 1 of the present embodiment can reduce failure in work.

Further, in step S6 shown in FIG. 6, the determination unit 34 of the present embodiment is configured to identify the determination target step, based on an image taken by any of the first imaging device 4 and the second imaging device 5. Alternatively, the determination unit 34 may identify the determination target step, in response to reception of input from the worker H1.

For example, when completing operation in a step, the worker H1 produces predetermined word(s) (e.g., “next”) for ordering start of determination. In the work assistance system 1, the speech recognition module 312 performs speech recognition on a speech input from the microphone 6. When determining that the predetermined word(s) for ordering start of determination are input, the determination unit 34 identifies the current step (the current determination target step) based on input from the worker H1.

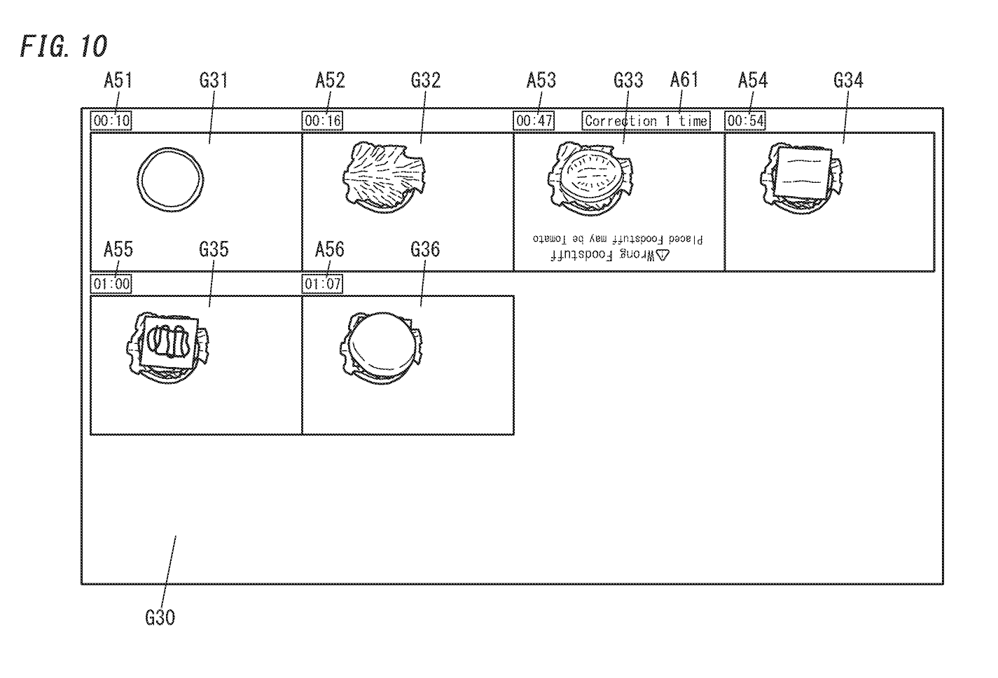

Additionally, the work assistance system 1 of the present embodiment enables subsequent confirmation of the recorded image obtained by shooting the work result done by the worker H1. A supervisor for supervising the worker H1 or work of the worker H1 designates a worker who has done the work, the date, and the like, and inputs instructions to display the recorded image into the work assistance system 1 by gestures, speeches, and the like. When the controller 3 receives the instructions to display the recorded image, the picture control unit 32 generates, based on the recorded image stored in the storage device 8, a work record screen G30 (see FIG. 10) displaying the recorded image designated. The picture control unit 32 projects the generated work record screen G30 from the projection device 2 onto the work surface 101 of the cooking counter 100. In the work record screen G30, individual images G31 to G36 obtained by shooting the work area 110 at the individual steps are arranged in chronological order. The images G31 to G36 include display areas A51 to A56 positioned in the upper left side and displaying elapsed time from start of the work to the end of a corresponding step, respectively. When a step having a work result determined to be unacceptable is present, the picture control unit 32 may display the number of times that the work result is determined to be unacceptable, in a vicinity of an image corresponding to the step the work result of which is determined to be unacceptable. In the example shown in FIG. 10, a display area A61 on the upper-right side of the image G33 shows the number of times that the work result is determined to be unacceptable, by texts or the like. In FIG. 10, the display area A61 shows “Number of times of correction is 1”. The supervisor supervising the worker H1 or work of the worker H1 can confirm a work result of a step whose work result is determined to be unacceptable, based on the images G31 to G36 corresponding to the individual images displayed on the work record screen G30. Note that, in the present embodiment, the work record screen G30 includes an image obtained by shooting the work area in each of the plurality of steps. Accordingly, it is possible to confirm a work result of a step whose work result is determined to be acceptable.

Note that, the work assistance system 1 may not be limited to projecting the work record screen G30 onto the work surface 101 of the cooking counter 100, but may display the work record screen G30 on a monitor of a terminal device capable of communicating with the controller 3 directly or via a network. Additionally, in the work record screen G30, the number of times of occurrence of work defect, information of the work defect, and the like may be shown in a vicinity of each of the images G31 to G36 corresponding to the steps. Therefore, the supervisor supervising the worker H1 or work of the worker H1 can confirm a work result, based on the images G31 to G36 corresponding to the individual steps displayed on the work record screen G30. Note that, the work assistance system 1 may store a dynamic image corresponding to each of steps in the storage device 8. The work record screen G30 may display a dynamic image corresponding to each of steps. Alternatively, the work assistance system 1 may not display an image corresponding to each of images on the work record screen G30, but may display only text data such as elapsed time of each step, the number of times of correction, work data, and the like.

### (3) Variations

The above embodiment may be only one of various embodiments according to the present disclosure. The above embodiment may be modified in various ways in accordance with design or the like, as long as they can achieve the purpose of the present disclosure. Note that, a function equivalent to the work assistance system 1 or a kitchen assistance system may be realized by a work assisting method, a computer program, a program recorded non-transitive recording medium, or the like. The work assisting method of one aspect includes a determination process and an announcement control process. The determination process is a process of determining whether a work result of a determination target step of a plurality of steps is acceptable or unacceptable, based on an image of a work area (the work surface 101 of the cooking counter 100). The announcement control process is a process of ordering an announcement unit (the projection device 2 or the speaker 7) to perform announcement operation, when the work result of the determination target step has been determined to be unacceptable by the determination process. The (computer) program of one aspect is a program enabling a computer system to execute the determination process and the announcement control process.

Hereinafter, variations of the above embodiment are listed. The variations described below may be applicable in appropriate combination.

The work assistance system 1, the kitchen assistance system, or one or more entities implementing the work assisting method in the present disclosure include a computer system. The computer system includes main hardware components including one or more processors and one or more memories. The one or more processors execute one or more programs recorded in the one or more memories of the computer system, thereby functioning as the work assistance system 1, the kitchen assistance system, or one or more entities implementing the work assisting method in the present disclosure. Such one or more programs may be stored in the one or more memories of the computer system in advance, or may be provided through telecommunication circuits, or may be provided with being recorded in one or more non-transitive recording media readable by computer systems. Examples of the non-transitive recording media readable by computer systems may include memory cards, optical disks, and hard disk drive. A processor of such a computer system may include one or more electronic circuits including a semiconductor integrated circuit (IC) or a large scale integrated circuit (LSI). The electronic circuits may be aggregated into one chip, or distributed to chips. The chips may be aggregated into one device, or distributed to devices.

The work assistance system 1 includes the controller 3, the first imaging device 4, the second imaging device 5, and the projection device 2. Alternatively, the work assistance system 1 can be realized by a single device where components are accommodated in a single case.

Note that, in the above embodiment, the work assistance system 1 includes the first imaging device 4 and the second imaging device 5 which serve as a camera for shooting the work area 110. However, the work assistance system 1 may include at least one of the first imaging device 4 and the second imaging device 5. Further, the work assistance system 1 includes the projection device 2 but the projection device 2 is optional for the work assistance system 1 and therefore the projection device 2 can be omitted.

Note that, in the above embodiment, a function of at least one of the determination unit 34, the announcement control unit 35 and the instruction control unit 36 included in the work assistance system 1 may be distributed to two or more systems. Or, individual functions of the determination unit 34, the announcement control unit 35 and the instruction control unit 36 may be distributed to a plurality of devices. Alternatively, one or more of functions of the work assistance system 1 may be implemented by the cloud (cloud computing), for example.

In the work assistance system 1 of the present embodiment, the worker H1 prepares one food in the work area 110 but may cook a plurality of foods (a plurality of the same type of foods, or a plurality of different types of foods) in parallel. In such a case, the picture control unit 32 may project a plurality of cooking instruction screens corresponding to the plurality of foods, toward the work area 110, by controlling the projection device 2.

The picture control unit 32 may project a picture for displaying a timer onto the work surface 101 of the cooking counter 100 by controlling the projection device 2. For example, the picture control unit 32 may project a picture of countdown of time for deep-fried foods, cooked foods, or the like, from the projection device 2 onto the work surface 101 of the cooking counter 100. This enables cooking deep-fried foods, cooked foods, or the like, while looking at a picture of countdown displayed on the work surface 101.

The instruction control unit 36 may project different cooking instruction screens by the projection device 2, for different workers H1. For example, the instruction control unit 36 may change the cooking instruction screen depending on a level of skill of the worker H1. The instruction control unit 36 may project the cooking instruction screen giving more detailed information when the level of skill of the worker H1 is lower. Alternatively, the instruction control unit 36 may stop displaying the cooking instruction screen in response to stop instructions inputted by the worker H1 with gesture or speech, for example. For example, if the worker H1 becomes skillful in the work and no longer needs the work instructions, the worker H1 may stop displaying the cooking instruction screen by the instruction control unit 36. Thus, it is possible to stop displaying unnecessary cooking instruction screens.

The infrared irradiator 51 of the second imaging device 5 of the present embodiment irradiates a whole of a distance measurement region with infrared light, and the infrared camera 52 receives a plane of light reflected from objects. However, the infrared irradiator 51 may sweep the distance measurement region with infrared light by changing a direction of irradiation of the infrared light. In this case, the infrared camera 52 receives a point of light reflected from objects. Note that, the infrared irradiator 51 may be optional for the work assistance system 1. If the infrared camera 52 can take images based on natural light or illumination light, the infrared irradiator 51 may be omitted appropriately.

The infrared irradiator 51 and the infrared camera 52 of the second imaging device 5 are used to measure distances to objects by the TOF method. However, such distances to objects can be measured by a pattern projection method (light coding method) or a stereo camera. Note that, the infrared camera 52 can be replaced with a combination of a CMOS image sensor or a CCD image sensor and an infrared transmission filter.

The second imaging device 5 measures distances to objects by use of infrared light with the infrared irradiator 51 and the infrared camera 52, but may measure distances to objects by an ultrasonic wave, a radio wave, or the like.

The object identification unit 33 detects objects present in the work area 110 by use of images taken by the RGB camera 53 and images taken by the infrared camera 52 but may detect objects present in the work area 110 based on images taken by the first imaging device 4. For example, the object identification unit 33 may conduct background subtraction to subtract background images from images taken by the first imaging device 4, thereby detecting objects present in the work area 110. Alternatively, the object identification unit 33 may detect objects present in the work area 110 based on images taken by the first imaging device 4 and images taken by the RGB camera 53 both. Alternatively, the object identification unit 33 may detect objects present in the work area 110 by use of at least one of images taken by the RGB camera 53, images taken by the infrared camera 52, and images taken by the first imaging device 4.

In the work assistance system 1 of the present embodiment, the projection device 2 projects a picture such as the cooking instruction screen onto the work surface 101. However, one or some of pictures such as the cooking instruction screen may be displayed by an additional display device. For example, the work assistance system 1 may not project the cooking instruction screen for indicating the cooking procedure, the picture for announcing defect in the work, the recorded image, and the like onto the work surface 101, but may display them by use of the additional display device. Examples of the additional device may include a liquid display device and a tablet terminal which are placed in a vicinity of the work area 110. When the picture control unit 32 displays the cooking instruction screen or the like by use of the additional display device, it is possible to reduce the number of pictures projected onto the work surface 101 of the cooking counter 100 other than pictures projected onto foodstuffs, foods for receiving foodstuffs, containers for receiving foodstuffs, and the like. Thus, it is possible to efficiently use the work surface 101 of the cooking counter 100.

The above embodiment includes the first imaging device 4 for shooting the work area 110 from the above and the second imaging device 5 for shooting the work area 110 from the front. However, the number of imaging devices and shooting directions can be changed appropriately.

The work assistance system 1 and the kitchen assistance system of the above embodiment are described with reference to an example of cooking a hamburger. However, a food to be prepared may not be limited to a hamburger, but may be parfait such as fruit parfait. The determination unit 34 may determine whether a work result is acceptable or unacceptable, based on an image of a work area taken in each step for preparing parfait. When the determination unit 34 has determined that the work result is unacceptable, the announcement control unit 35 may order the projection device 2 serving as an announcement unit to perform announcement operation. Consequently, when defect has occurred in the work procedure in a step for preparing the parfait, it is possible to announce that the work result of the step is unacceptable.

The work assistance system 1 of the present embodiment is used in the kitchen in the fast-food restaurant, but may be used in a kitchen of a restaurant, a hotel, or the like. Alternatively, the work assistance system 1 of the embodiment may be used in a cooking place for prepared foods in a backyard of a supermarket, a food processing plant, or the like.

Alternatively, the work assistance system 1 of the above embodiment may not be limited to being used in premises where foods are prepared in response to purchase or order of foods from customers or the like, but may be used in an ordinary home. In this case, when a user of the work assistance system 1 decides cooking procedure of a food to be prepared and inputs it into the controller 3, the controller 3 projects a picture for assisting cooking onto a cooking space in accordance with the input cooking procedure.

The work assistance system 1 of the above embodiment is used for assisting cooking work in a kitchen. Alternatively, the work assistance system 1 may be used for assisting work other than the cooking work, as long as such work includes a plurality of steps. For example, the work assistance system 1 may be used for assisting work including a plurality of steps in a factory or the like, such as, assembling work of assembling a target object, disassembling work of disassembling a target object, cleaning work of cleaning a target object, and maintenance work of maintaining an object.

(Aspects)

As described above, a first aspect is a work assistance system (1) which is a system for assisting work including a plurality of steps and includes: a determination unit (34); and an announcement control unit (35). The determination unit (34) is configured to determine whether a work result of a determination target step of the plurality of steps is acceptable or unacceptable, based on an image of a work area (110). The announcement control unit (35) is configured to order an announcement unit (2, 7) to perform announcement operation, when the work result of the determination target step has been determined to be unacceptable by the determination unit (34).

According to this aspect, when the work result of the determination target step has been determined to be unacceptable in the determination unit (34), the announcement control unit (35) enables the announcement unit (2, 7) to perform the announcement operation. Therefore, workers can easily find the work result is unacceptable, and accordingly failure in work can be reduced.

A second aspect is based on the work assistance system (1) according to the first aspect, wherein the announcement control unit (35) is configured to, when the work result of the determination target step has been determined to be unacceptable by the determination unit (34), order the announcement unit (2, 7) to perform the announcement operation before an action in a step next to the determination target step is started.

Accordingly, this aspect enables a worker to find that the step the work result of which is unacceptable has been done before start of the action in the next step.

A third aspect is based on the work assistance system (1) according to the first or second aspect, further including an instruction control unit (36) configured to order an instruction unit (2, 7) to give work instructions of a next step of the plurality of steps.

According to this aspect, the instruction control unit (36) makes the instruction unit (2, 7) to give work instructions of the next step. Therefore, workers can perform work even if they are unaccustomed to the work.

A fourth aspect is based on the work assistance system (1) according to the third aspect, wherein the instruction control unit (36) is configured to prohibit the instruction unit (2, 7) from giving the work instructions of the next step, when the work result of the determination target step has been determined to be unacceptable by the determination unit (34).

According to this aspect, it is possible to reduce probabilities that the work result is unacceptable but workers perform the next step nonetheless.

A fifth aspect is based on the work assistance system (1) according to any one of the first to fourth aspects, wherein the determination unit (34) is configured to identify the determination target step, based on the image.

According to this aspect, the determination target step is determined based on the image of the work area. Therefore, it is unnecessary for workers to input the determination target step.

A sixth aspect is based on the work assistance system (1) according to any one of the first to fifth aspects, wherein the determination unit (34) is configured to identify the determination target step, in response to reception of input from a worker.

According to this aspect, workers can determine the determination target step by input from themselves.

A seventh aspect is based on the work assistance system (1) according to any one of the first to sixth aspects, wherein the announcement control unit (35) is configured to, when the work result of the determination target step has been determined to be unacceptable by the determination unit (34), order the announcement unit (2, 7) to announce a predetermined item. The predetermined item is a correction item for correcting the work result determined to be unacceptable.

According to this aspect, workers can correct the work result determined to be unacceptable, in accordance with a correction item announced by the announcement unit (2, 7).

An eighth aspect is based on the work assistance system (1) according to any one of the first to seventh aspects, wherein the determination unit (34) is configured to determine whether the work result of the determination target step is acceptable or unacceptable, based on an image of a scene where a plurality of objects (71 to 77) to be dealt are combined.

According to this aspect, the determination unit (34) can determine whether the work result is acceptable or unacceptable, even if the plurality of objects (71 to 77) are combined.

A ninth aspect is based on the work assistance system (1) according to any one of the first to eighth aspects, wherein the determination unit (34) is configured to store in a storage unit (8) the image of the work area (110) in a step which is one of the plurality of steps and the work result of which has been determined to be unacceptable.

According to this aspect, it is possible to determine, based on images stored in the storage unit (8), whether the work result is acceptable or unacceptable.

A tenth aspect is based on the work assistance system (1) according to the ninth aspect, wherein the determination unit (34) is configured to store defective information indicative of defect in the storage device (8) in association with the image of the work area (110) in a step a work result of which has been determined to be unacceptable.

An eleventh aspect is based on the work assistance system (1) according to the ninth aspect, wherein the determination unit (34) is configured to store correction information indicative a correction item for correcting defect in the storage device (8) in association with the image of the work area (110) in a step a work result of which has been determined to be unacceptable.

A twelfth aspect is based on the work assistance system (1) according to any one of the first to eleventh aspects, further including an imaging device (4, 5) for shooting the work area (110), and the image of the work area (110) is taken by the imaging device (4, 5).

Accordingly, this aspect enables reducing failure in work.

Note that, configurations according to the second to twelfth aspects are optional for the work assistance system (1), and may be omitted appropriately.

A thirteenth aspect is a kitchen assistance system including the work assistance system (1) according to any one of the first to twelfth aspects, wherein the work including the plurality of steps is cooking work in a kitchen.

Accordingly, this aspect enables reducing failure in work.

A fourteenth aspect is a work assisting method including: a determination process (step S7 in FIG. 6); and an announcement control process (step S11 in FIG. 6). The determination process is a process of determining whether a work result of a determination target step of a plurality of steps is acceptable or unacceptable, based on an image of a work area (110). The announcement control process is a process of ordering an announcement unit (2, 7) to perform announcement operation, when the work result of the determination target step has been determined to be unacceptable by the determination process.

According to this aspect, when the work result of the determination target step has been determined to be unacceptable in the determination step, the announcement control step enables the announcement unit (2, 7) to perform the announcement operation. Therefore, workers can easily find that the work result is unacceptable, and accordingly failure in work can be reduced.

A fifteenth aspect is a non-transitive computer-readable medium recording a program for instructing a computer system to execute: a determination process (step S7 in FIG. 6); and an announcement control process (step S11 in FIG. 6). The determination process is a process of determining whether a work result of a determination target step of a plurality of steps is acceptable or unacceptable, based on an image of a work area (110). The announcement control process is a process of ordering an announcement unit (2, 7) to perform announcement operation, when the work result of the determination target step has been determined to be unacceptable by the determination process.

According to this aspect, when the work result of the determination target step has been determined to be unacceptable in the determination step, the announcement control step enables the announcement unit (2, 7) to perform the announcement operation. Therefore, workers can easily find the work result is unacceptable, and accordingly failure in work can be reduced.

A sixteenth aspect is based on the work assistance system (1) according to any one of the first to twelfth aspects, wherein the announcement unit (2, 7) is configured to display an instruction screen (G21) on a work surface (101).

A seventeenth aspect is based on the work assistance system (1) according to any one of the first to twelfth and sixteenth aspects, wherein the announcement unit (2, 7) is configured to display an announcement screen (G22) on a work surface (101).

1. A work assistance system for assisting work including a plurality of steps, the system comprising:
a determination unit configured to determine whether a work result of a determination target step of the plurality of steps is acceptable or unacceptable, based on an image of a work area; and
an announcement control unit configured to order an announcement unit to perform announcement operation, when the work result of the determination target step has been determined to be unacceptable by the determination unit.

2. The work assistance system according to claim 1, wherein
the announcement control unit is configured to, when the work result of the determination target step has been determined to be unacceptable by the determination unit, order the announcement unit to perform the announcement operation before an action in a step next to the determination target step is started.

3. The work assistance system according to claim 1, further comprising an instruction control unit configured to order an instruction unit to give work instructions of a next step of the plurality of steps.

4. The work assistance system according to claim 2, further comprising an instruction control unit configured to order an instruction unit to give work instructions of a next step of the plurality of steps.

5. The work assistance system according to claim 3, wherein
the instruction control unit is configured to prohibit the instruction unit from giving the work instructions of the next step, when the work result of the determination target step has been determined to be unacceptable by the determination unit.

6. The work assistance system according to claim 4, wherein
the instruction control unit is configured to prohibit the instruction unit from giving the work instructions of the next step, when the work result of the determination target step has been determined to be unacceptable.

7. The work assistance system according to claim 3, wherein
the instruction unit is configured to display an instruction screen for giving the work instructions, on a work surface.

8. The work assistance system according to claim 1, wherein
the determination unit is configured to identify the determination target step, based on the image.

9. The work assistance system according to claim 1, wherein
the determination unit is configured to identify the determination target step, in response to reception of input from a worker.

10. The work assistance system according to claim 1, wherein
the announcement control unit is configured to, when the work result of the determination target step has been determined to be unacceptable by the determination unit, order the announcement unit to announce a correction item for correcting the work result determined to be unacceptable.

11. The work assistance system according to claim 2, wherein
the announcement control unit is configured to, when the work result of the determination target step has been determined to be unacceptable by the determination unit, order the announcement unit to announce a correction item for correcting the work result determined to be unacceptable.

12. The work assistance system according to claim 3, wherein
the announcement control unit is configured to, when the work result of the determination target step has been determined to be unacceptable by the determination unit, order the announcement unit to announce a correction item for correcting the work result determined to be unacceptable.

13. The work assistance system according to claim 4, wherein
the announcement control unit is configured to, when the work result of the determination target step has been determined to be unacceptable by the determination unit, order the announcement unit to announce a correction item for correcting the work result determined to be unacceptable.

14. The work assistance system according to claim 1, wherein
the determination unit is configured to determine whether the work result of the determination target step is acceptable or unacceptable, based on an image of a scene where a plurality of objects to be dealt are combined.

15. The work assistance system according to claim 1, wherein
the determination unit is configured to store in a storage unit the image of the work area in a step which is one of the plurality of steps and the work result of which has been determined to be unacceptable.

16. The work assistance system according to claim 1, wherein
the announcement unit is configured to display an announcement screen on a work surface.

17. The work assistance system according to claim 1, further comprising an imaging device for shooting the work area, the image of the work area being taken by the imaging device.

18. A kitchen assistance system comprising: the work assistance system according to claim 1, wherein
the work including the plurality of steps is cooking work in a kitchen.

19. A work assisting method comprising:
a determination process of determining whether a work result of a determination target step of a plurality of steps is acceptable or unacceptable, based on an image of a work area; and
an announcement control process of ordering an announcement unit to perform announcement operation, when the work result of the determination target step has been determined to be unacceptable by the determination process.

20. A non-transitive computer-readable medium recording a program for instructing a computer system to execute:
a determination process of determining whether a work result of a determination target step of a plurality of steps is acceptable or unacceptable, based on an image of a work area; and
an announcement control process of ordering an announcement unit to perform announcement operation, when the work result of the determination target step has been determined to be unacceptable by the determination process.
